(19) United States
(12) Patent Application Publication
(10) Pub. No.: US 2008/0129728 A1
(43) Pub. Date: Jun. 5, 2008

(54) Image file creation device, imaging apparatus and file structure

(75) Inventor: Nakamura Satoshi, Asaka-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/987,338

(22) Filed: Nov. 29, 2007

(30) Foreign Application Priority Data
Dec. 1, 2006 (JP) 2006-326066

(51) Int. Cl. G06T 15/00

(52) U.S. Cl. 345/419

(57) ABSTRACT

An image file creation device comprises: a thumbnail image creation device which creates two or more types of thumbnail images on the basis of a three-dimensional image; a three-dimensional image file creation device which creates a three-dimensional image file from the three-dimensional image; and a thumbnail image file creation device which creates a thumbnail image file in which the created two or more types of thumbnail images are combined and recorded and which is associated with the three-dimensional image file. Thus, the thumbnail image file in which two or more types of thumbnail images corresponding to the three-dimensional image are combined and recorded is also created together with the three-dimensional image file. Therefore, this thumbnail image file has compatibility with 3D image reproduction devices having various specifications for thumbnail image reproduction.

### BACKGROUND OF THE INVENTION

1. Field of the Invention

The present invention relates to an image file creation device, an imaging apparatus and a file structure, and in particular to a technique about a thumbnail image of a three-dimensional image (hereinafter referred to as a “3D image”) constituted by multiple images obtained by capturing images of the same subject from multiple viewpoints.

2. Description of the Related Art

There has been conventionally proposed an image data creation device for creating an image file in which a 3D image, which is image information corresponding to multiple viewpoints, the thumbnail image of the 3D image, and three-dimensional control information for displaying the 3D image as a 3D image are recorded (Japanese Patent Application Laid-Open No. 2004-349731).

In Japanese Patent Application Laid-Open No. 2004-349731, multiple types of thumbnail images shown below are described, as the thumbnail image corresponding to a 3D image.

(1) An image in which the images from all the viewpoints of the 3D image are reduced and arranged;

(2) an image obtained by extracting an image corresponding to one viewpoint from 3D image and reducing it; and

(3) an image in which a symbol indicating that the 3D image is a 3D image is embedded.

There is also proposed an image file creation device for creating a three-dimensional image file (3D image file) in which a 3D image is recorded and a thumbnail image file in which a two-dimensional image (hereinafter referred to as a “2D image”) is recorded as the thumbnail image of the 3D image (Japanese Patent Application Laid-Open No. 2004-349732). The 3D image file and the thumbnail image file corresponding to the 3D image file are named in accordance with the naming rules of DCF (Design rule for Camera File system: the unified recording format for digital cameras), and the two image files are named with the same filename and different extensions, and thereby they are associated with each other.

In Japanese Patent Application Laid-Open No. 2004-349731, an example of the multiple types of thumbnail is described as the thumbnails image corresponding to a 3D image. However, it is one thumbnail image that is recorded in one image file. Therefore, even a 3D image reproduction device capable of reproducing various thumbnail images can display only one fixed thumbnail image recorded in an image file in advance. Therefore, for example, there is a problem that it is not possible to, when the recommended thumbnail image differs according to apparatuses, display the thumbnail image recommended by each apparatus or display the thumbnail image of the type set by a user in advance.

In Japanese Patent Application Laid-Open No. 2004-349732, there is not description about the types of thumbnail image compatible with a 3D image. Therefore, in the case of reproducing a thumbnail image by an image reproduction device for reproducing a 3D image, on the basis of a thumbnail image file in which a 2D image thumbnail image is recorded, only the one fixed thumbnail image recorded in the thumbnail image file can be displayed, and there are problems similar to those of the invention described in Japanese Patent Application Laid-Open No. 2004-349731.

### SUMMARY OF THE INVENTION

The present invention has been made in view of the above situation, and its object is to provide an image file creation device, an imaging apparatus, and a file structure, which are capable of recording multiple thumbnail images of different types which have been created as the thumbnail images of a 3D image and thereby have compatibility with 3D image reproduction devices having various specifications for thumbnail image reproduction, and further enable a thumbnail image for a 3D image set by a user in advance to be reproduced.

In order to achieve the above object, an image file creation device according to a first aspect of the present invention comprises: an image acquisition device which acquires a three-dimensional image constituted by multiple images obtained by capturing images of the same subject from multiple viewpoints; a thumbnail image creation device which creates two or more types of thumbnail images on the basis of the acquired three-dimensional image; a three-dimensional image file creation device which creates a three-dimensional image file from the acquired three-dimensional image; and a thumbnail image file creation device which creates a thumbnail image file in which the created two or more types of thumbnail images are combined and recorded and which is associated with the three-dimensional image file.

That is, the thumbnail image file in which two or more types of thumbnail images corresponding to the three-dimensional image are combined and recorded is also created together with the three-dimensional image file. Due to this thumbnail image file, it is possible to have compatibility with 3D image reproduction devices having various specifications for thumbnail image reproduction. Furthermore, it is also possible to reproduce a thumbnail image in a desired preset form.

The thumbnail image can be created from an original image (three-dimensional image) at the time of reproduction. In this case, the creation of the thumbnail image requires time. Especially when a lot of three-dimensional image files are recorded, a long waiting time is required before all the thumbnail images are displayed. However, by referring to the thumbnail image file created in advance, it is possible to display the thumbnail images quickly.

According to a second aspect of the present invention in the image file creation device according to the first aspect, the three-dimensional image file creation device records one of the created two or more types of thumbnail images in the three-dimensional image file. Thereby, even in the case of a reproduction device which does not refer to a thumbnail image file, it is possible to reproduce the thumbnail image of a 3D image quickly without newly creating a thumbnail image from the 3D image.

An image file creation device according to a third aspect of the present invention comprises: an image acquisition device which acquires a three-dimensional image constituted by multiple images obtained by capturing images of the same subject from multiple viewpoints; a thumbnail image creation device which creates two or more types of thumbnail images on the basis of the acquired three-dimensional image; a three-dimensional image file creation device which creates a three-dimensional image file from the acquired three-dimensional image and one of the created two or more types of thumbnail images; and a thumbnail image file creation device which creates a thumbnail image file in which one or more types of thumbnail images among the created two or more types of thumbnail images, excluding the thumbnail image included in the three-dimensional image file, are recorded and which is associated with the three-dimensional image file.

That is, the two or more types of thumbnail images created for the 3D image are divided and recorded separately in the three-dimensional image file and the thumbnail image file. Since one thumbnail image is recorded in the three-dimensional image file, it is possible even for a reproduction device which does not refer to the thumbnail image file, to reproduce the thumbnail image of the 3D image quickly. Furthermore, a reproduction device which refers to the thumbnail image file is capable of selecting a desired thumbnail image from among the two or more types of thumbnail images and reproducing it.

An image file creation device according to a fourth aspect of the present invention comprises: an image acquisition device which acquires a three-dimensional image constituted by multiple images obtained by capturing images of the same subject from multiple viewpoints; a thumbnail image creation device which creates two or more types of thumbnail images on the basis of the acquired three-dimensional image; and a three-dimensional image file creation device which creates from the acquired three-dimensional image, a three-dimensional image file in which the two or more types of thumbnail images created by the thumbnail image creation device are recorded.

According to this, since the multiple types of thumbnail images are recorded in the three-dimensional image file together with the three-dimensional image, the necessity of creation of a thumbnail image file is eliminated.

According to a fifth aspect of the present invention, the image file creation device according to any of the first to third aspects, further comprises a tag data creation device which creates management information for managing the created two or more types of thumbnail images; and the thumbnail image file creation device records the management information in the thumbnail image file. It is possible to reproduce a desired thumbnail image on the basis of the management information recorded in the thumbnail image file.

According to a sixth aspect of the present invention, in the image file creation device according to the fifth aspect, the thumbnail image file creation device records the management information immediately after the header of the thumbnail image file. According to this, it becomes possible to select a thumbnail image to be reproduced before reading thumbnail images, and it is possible to read only the thumbnail image to be reproduced.

According to a seventh aspect of the present invention, in the image file creation device according to the fifth aspect, characterized in that the thumbnail image file creation device records the management information immediately after the thumbnail image recorded immediately after the header of the thumbnail image file. According to this, even a reproduction device which does not support reproduction of multiple types of thumbnail images (which cannot refer to the management information) can reproduce the thumbnail image recorded immediately after the header and secure compatibility.

According to an eighth aspect of the present invention, the image file creation device according to the fourth aspect, further comprises a tag data creation device which creates management information for managing the created two or more types of thumbnail images; and the three-dimensional image file creation device records the management information in the three-dimensional image file.

According to a ninth aspect of the present invention, in the image file creation device according to any of the fifth to eighth aspects, the management information includes a thumbnail image identifier which identifies the type of a thumbnail image. It is possible to easily select the type of a thumbnail image to be reproduced, in a reproduction device.

An imaging apparatus according to a tenth aspect of the present invention comprises: the image file creation device according to any of the first to seventh aspects, other than the forth aspect; an imaging device which captures a plurality of images of the same subject from multiple viewpoints and outputs the plurality of images to the image acquisition device; and a storage device which stores the three-dimensional image file created by the three-dimensional image file creation device and the thumbnail image file created by a thumbnail image file creation device in a storage medium.

An eleventh aspect of the present invention shows a file structure of a thumbnail image file in which multiple different types of thumbnail images are combined and recorded, the multiple thumbnail images being created from a three-dimensional image constituted by multiple images obtained by capturing images of the same subject from multiple viewpoints, and in the file structure, a first thumbnail image among the multiple thumbnail images is recorded immediately after a header; management information managing the multiple thumbnail images is recorded immediately after the first thumbnail image; and the thumbnail images other than the first thumbnail image are recorded immediately after the management information.

According to this file structure, even a reproduction device which does not support reproduction of multiple types of thumbnail images can reproduce the thumbnail image recorded immediately after the header and secure compatibility.

A twelfth aspect of the present invention shows file structure of a three-dimensional image file in which a three-dimensional image constituted by multiple images obtained by capturing images of the same subject from multiple viewpoints and multiple different types of thumbnail images created from the three-dimensional image are recorded, and in the file structure, a first thumbnail image among the multiple thumbnail images is recorded immediately after a header; management information managing the multiple thumbnail images is recorded immediately after the first thumbnail image; the thumbnail images other than the first thumbnail image are recorded immediately after the management information; and the three-dimensional image is recorded immediately after the multiple thumbnail images.

A thirteenth aspect of the present invention shows a file structure of a three-dimensional image file in which a three-dimensional image constituted by multiple images obtained by capturing images of the same subject from multiple viewpoints and multiple different types of thumbnail images created from the three-dimensional image are recorded, and in the file structure, a first thumbnail image among the multiple thumbnail images is recorded immediately after a header; the three-dimensional image is recorded immediately after the first thumbnail image; management information managing the multiple thumbnail images is recorded immediately after the three-dimensional image; and the thumbnail images other than the first thumbnail image are recorded immediately after the management information.

According to a fourteenth aspect of the present invention, in the file structure according to the eleventh or twelfth aspect, the three-dimensional image is an integrated image obtained by integrating multiple images as one image or an image obtained by separating and combining images corresponding to respective viewpoints.

A fifteenth aspect of the present invention shows a file structure of a three-dimensional image file in which a three-dimensional image constituted by multiple images obtained by capturing images of the same subject from multiple viewpoints and multiple different types of thumbnail images created from the three-dimensional image are recorded, and in the file structure, a first thumbnail image among the multiple thumbnail images is recorded immediately after a header; an image corresponding to a first viewpoint of the three-dimensional image is recorded immediately after the first thumbnail image; management information managing the multiple thumbnail images is recorded immediately after the image corresponding to the first viewpoint; the thumbnail images other than the first thumbnail image are recorded immediately after the management information; and the images other than the image corresponding to the first viewpoint, of the three-dimensional image are recorded immediately after the multiple thumbnail images.

According to the twelfth to fifteenth aspects, even a reproduction device which does not refer to a thumbnail image file or a reproduction device which does not support reproduction of multiple types of thumbnail images can reproduce the thumbnail image recorded immediately after the header and further can reproduce the three-dimensional image.

According to a sixteenth aspect of the present invention, in the file structure according to any of the eleventh to fifteenth aspects, the management information includes a thumbnail image identifier which identifies the type of each thumbnail image. Thereby, it is possible to easily select a desired thumbnail image.

According to a seventeenth aspect of the present invention, in the file structure according to the sixteenth aspect, the management information includes information indicating the positions in the file of the thumbnail images other than the first thumbnail image among the multiple thumbnail images.

According to the aspects of the present invention, it is possible to record multiple different types of thumbnail images created as the thumbnail images of a 3D image, and thereby, it is possible to secure compatibility with 3D image reproduction devices having various specifications for thumbnail image reproduction, and it is also possible to reproduce a preset desired thumbnail image.

### BRIEF DESCRIPTION OF THE DRAWINGS

FIG. 1 is a block diagram showing the schematic configuration of an imaging apparatus (digital camera) according to the present invention;

FIG. 2 is a block diagram showing the internal configuration of an image file creation device in the digital camera;

FIG. 3A to 3D are diagrams showing an example of multiple types of thumbnail images created by a thumbnail image creation section;

FIG. 4 is a diagram showing an example of the file structure of a thumbnail image file;

FIG. 5A to 5D are diagrams showing an example of the file structure of a 3D image file;

FIG. 6 is a diagram showing the directory structure of a recording medium in which a 3D image file and a thumbnail image file are stored;

FIG. 7 is a diagram showing a file structure showing another embodiment of the thumbnail image file;

FIG. 8 is a diagram showing the directory structure of a recording medium in which a 3D image file and a thumbnail image file are stored;

FIG. 9 is a block diagram showing the internal configuration of an image reproduction device in the digital camera;

FIG. 10 is a flowchart showing an embodiment of an image reproduction operation performed in a reproduction mode;

FIG. 11 is a flowchart showing the details of a thumbnail image file reading procedure in the flowchart shown in FIG. 10;

FIG. 12 is a flowchart showing another embodiment of the image reproduction operation performed in the reproduction mode; and

FIG. 13A to 13C are diagrams showing a file structure showing another embodiment of the 3D image file.

### DETAILED DESCRIPTION OF THE PREFERRED EMBODIMENTS

Preferred embodiments of an image file creation device, an imaging apparatus and a file structure according to the present invention will be described below with reference to accompanying drawings.

### [Schematic Configuration of Digital Camera]

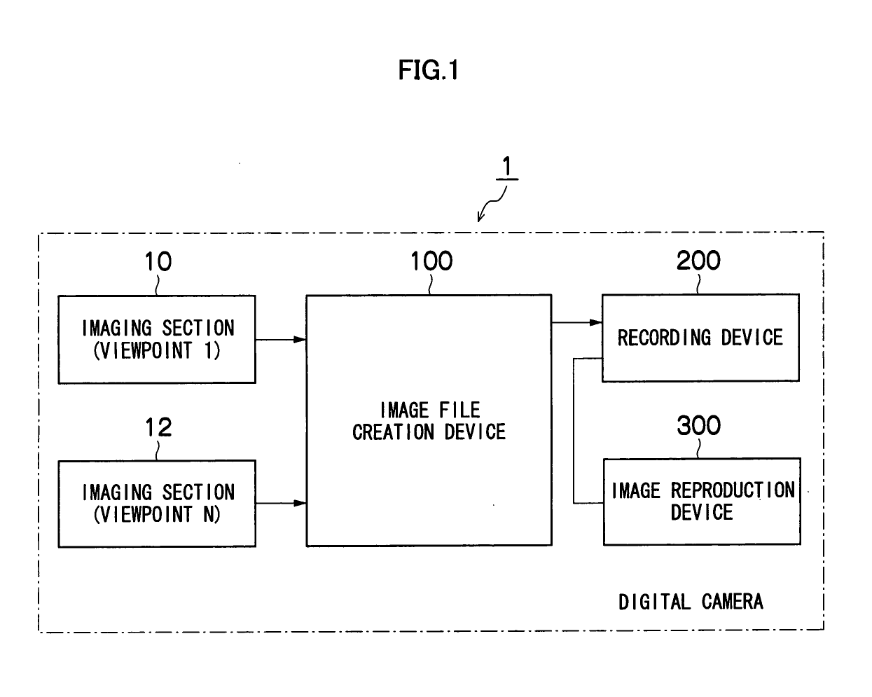

FIG. 1 is a block diagram showing the schematic configuration of the imaging apparatus according to the present invention.

This imaging apparatus (digital camera) 1 comprises imaging sections 10 and 12 for capturing images of the same subject from multiple viewpoints (a viewpoint 1 and a viewpoint N (N=2 or more)) to capture a 3D image, an image file creation device 100 for acquiring multiple images captured by these imaging sections 10 and 12, a recording device 200 for recording a 3D image file and a thumbnail image file created by the image file creation device 100 in an external recording medium such as a memory card or a recording medium included in the camera, and an image reproduction device 300 for reading the 3D image file and the thumbnail image file recorded in the recording medium and reproducing the 3D image and the thumbnail image.

### [Image File Creation Device]

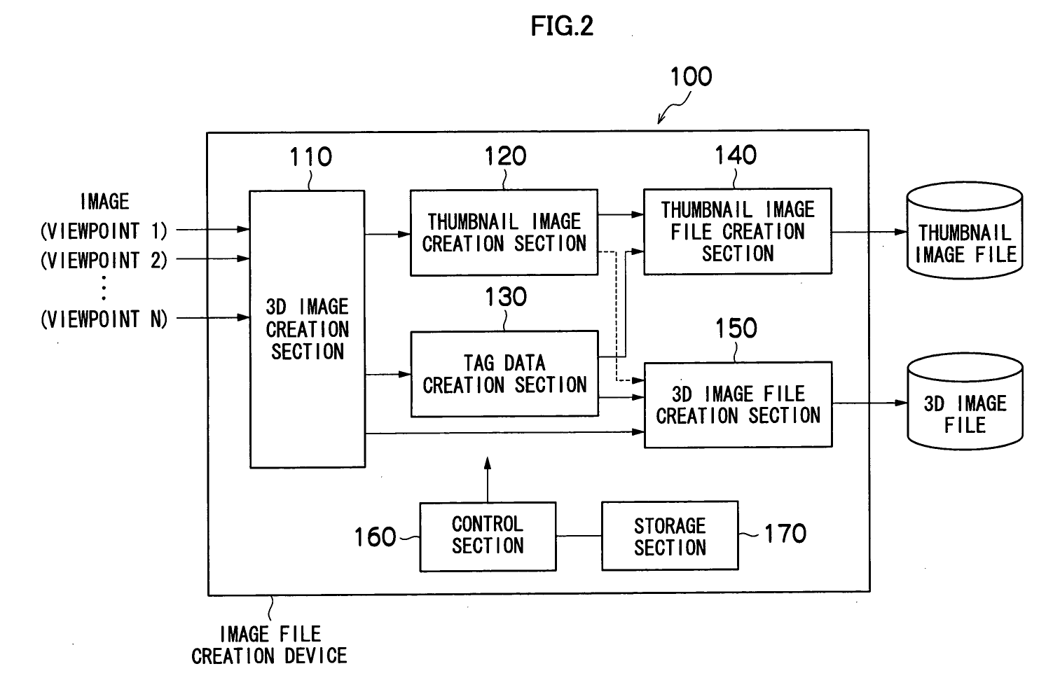

FIG. 2 is a block diagram showing the internal configuration of the image file creation device 100.

This image file creation device 100 mainly comprises a 3D image creation section 110, a thumbnail image creation section 120, a tag data creation section 130, a thumbnail image file creation section 140, a 3D image file creation section 150, a control section 160 and a storage section 170.

The control section 160 performs overall control of the components and controls them in accordance with a predetermined program. In the storage section 170, there are stored programs to be executed by the control section 160 and setting data and the like of the components.

The 3D image creation section 110 receives multiple images captured by the imaging sections 10 and 12 arranged at multiple viewpoint positions. In this embodiment, the 3D image creation section 110 creates a 3D image obtained by integrating multiple images into one image.

If the integrated 3D image is not created, the 3D image creation section 110 may be eliminated. The multiple images to be inputted to the 3D image creation section 110 include a range image indicating a camera-to-subject distance determined for each pixel of the image showing the subject, in addition to the multiple images obtained by capturing images of the same subject from multiple viewpoints. Furthermore, the 3D image creation section 110 can also generate a range image from the multiple images obtained by capturing images of the same subject from multiple viewpoints.

The thumbnail image creation section 120 creates multiple types of thumbnail images corresponding to the 3D image, on the basis of the integrated image created by the 3D image creation section 110 and the images from the multiple viewpoints before integration.

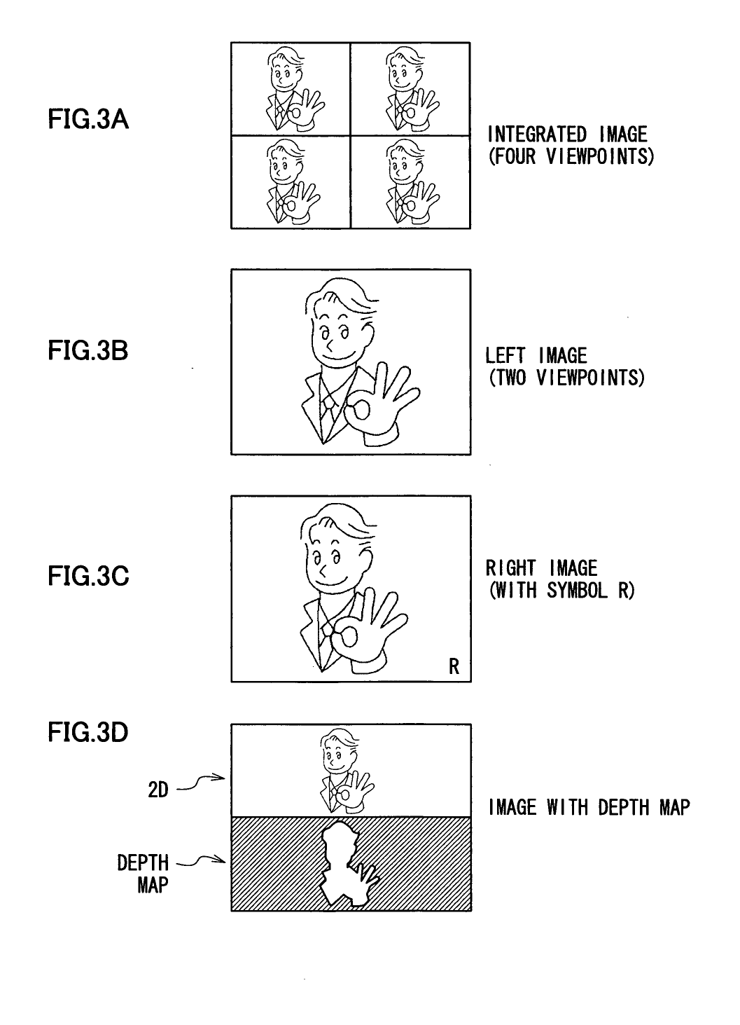

FIG. 3A to 3D show examples of the multiple types of thumbnail images created by the thumbnail image creation section 120.

FIG. 3A shows thumbnail images created by, when images from four viewpoints have been inputted and an integrated image (3D image) of four-viewpoints has been created by the 3D image creation section 110, reducing the integrated image.

FIG. 3B shows a thumbnail image created by, when images from two right and left viewpoints have been inputted, reducing only the left image (or the right image).

FIG. 3C shows a thumbnail image created by, when images from two right and left viewpoints have been inputted, reducing only the right image (or the left image) and then attaching a symbol mark (R) indicating that the image is the right image, to the reduced image.

FIG. 3D shows a thumbnail image created by, when a 2D image and a range image corresponding to the 2D image are inputted, integrating the 2D image reduced and the range image reduced. The range image is an image created by assigning a brighter pixel value as the distance is nearer.

The tag data creation section 130 creates tag data of a thumbnail image file and a 3D image file and outputs the tag data to the thumbnail image file creation section 140 and the 3D image file creation section 150, respectively. In the thumbnail image file to be described later, multiple types of thumbnail images are combined and recorded. Therefore, this tag data creation section 130 also creates management information for managing the multiple thumbnail images. Thus, the tag data creation section 130 creates tag data different from conventional tag data of image file.

The thumbnail image file creation section 140 creates a thumbnail image file on the basis of the multiple types of thumbnail images created by the thumbnail image creation section 120 and tag data for the thumbnail image file created by the tag data creation section 130.

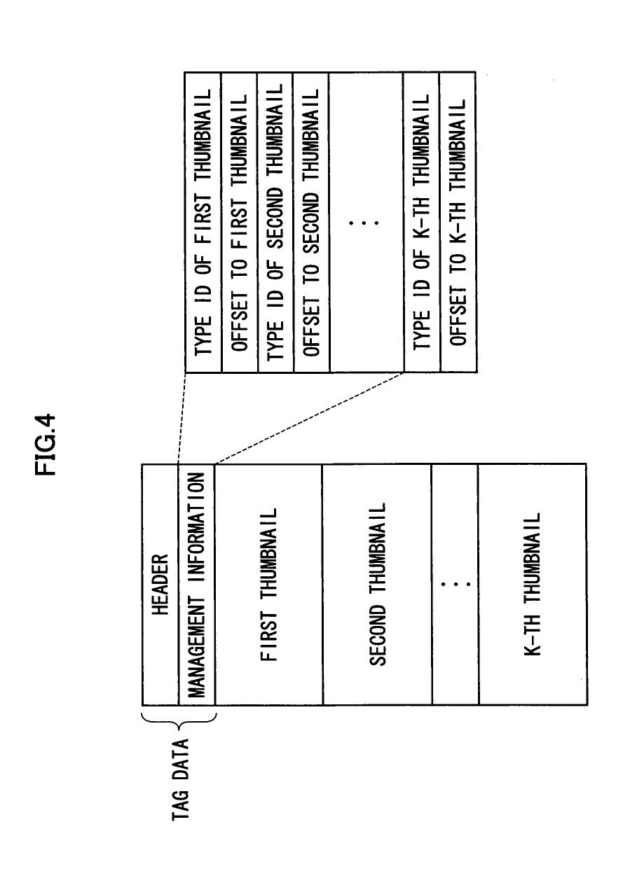

FIG. 4 shows an example of the file structure of the thumbnail image file created by the thumbnail image file creation section 140.

As shown in FIG. 4, in this thumbnail image file, management information about multiple types of thumbnail images are recorded immediately after the header, and the multiple (first, second, . . . K-th) thumbnail images are continuously recorded after the management information.

Here, the management information has a thumbnail image identifier (type ID) for identifying the type of each thumbnail image and an offset indicating the position (address) in the file where the thumbnail image corresponding to the type ID is recorded, as shown in FIG. 4.

Since the management information is recorded immediately after the header, it is possible to select a thumbnail image to be reproduced before reading thumbnail images, thereby it enables to read only the thumbnail image to be reproduced.

Meanwhile, the 3D image file creation section 150 creates a 3D image file on the basis of the integrated image (3D image) created by the 3D image creation section 110 and tag data for the 3D image file created by the tag data creation section 130.

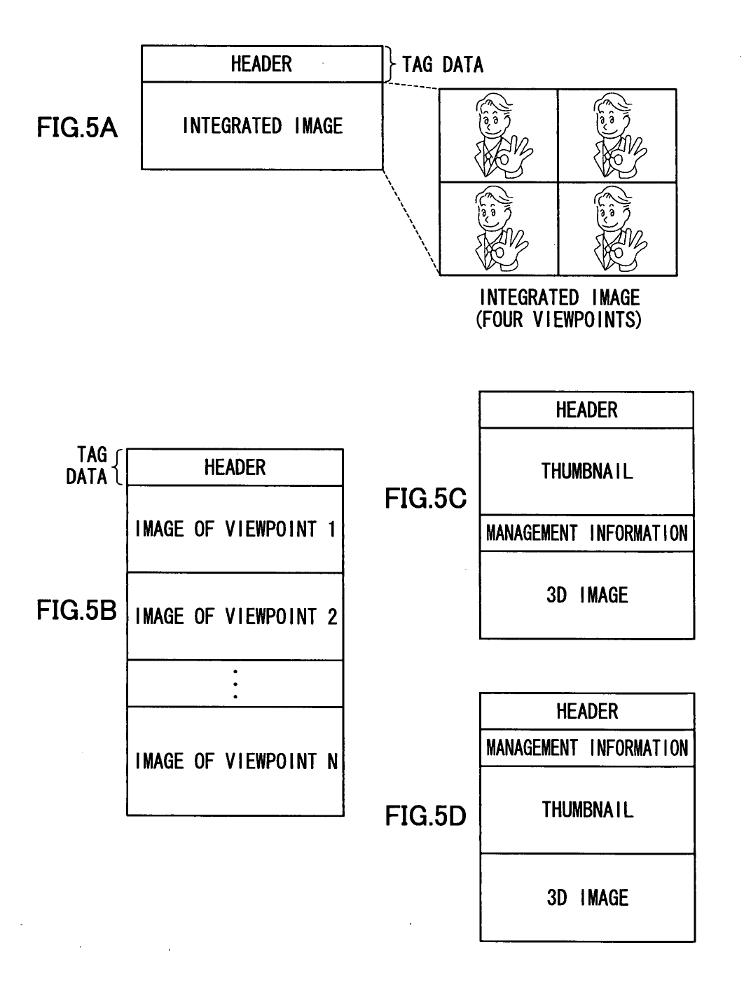

FIG. 5A to 5D show examples of the file structure of the 3D image file created by the 3D image file creation section 150.

The 3D image file shown in FIG. 5A has a file structure in which one integrated image (3D image) is recorded after the header where tag data is recorded. The tag data includes information indicating the areas of images from four viewpoints, information about the position of the viewpoint of each image (such as the base line length and the angle of convergence) and the like, and the information is used when reproduction is performed by a 3D image reproduction device.

The 3D image file shown in FIG. 5B has a file structure in which the frames of multiple images (3D image) captured from multiple viewpoints are sequentially combined after the header where tag data is recorded. The tag data includes information indicating the areas of the multiple images, information about the position of the viewpoint of each image (such as the base line length and the angle of convergence) and the like, and the information is used when reproduction is performed by a 3D image reproduction device.

The 3D image file shown in FIG. 5C has a file structure in which a thumbnail image is recorded after the header where tag data is recorded, management information about the thumbnail image is recorded after the thumbnail image, and a 3D image is recorded after the management information.

The 3D image file shown in FIG. 5D has a file structure in which management information is recorded after the header where tag data is recorded, a thumbnail image is recorded after the management information, and a 3D image is recorded after the thumbnail image.

In the case of creating the 3D image file shown in FIG. 5C or FIG. 5D, the 3D image file creation section 150 inputs one thumbnail among the multiple types of thumbnail images created by the thumbnail image creation section 120. As the management information, the thumbnail image identifier (type ID) of the thumbnail image in the 3D image file is recorded. As the 3D image to be recorded in the 3D image file shown in FIGS. 5C and 5D, any of the 3D images shown in FIGS. 5A and 5B is possible.

### [Recording Device]

The recording device 200 shown in FIG. 1 records the thumbnail image file created by the thumbnail image file creation section 140 and the 3D image file created by the 3D image file creation section 150 in a recording medium.

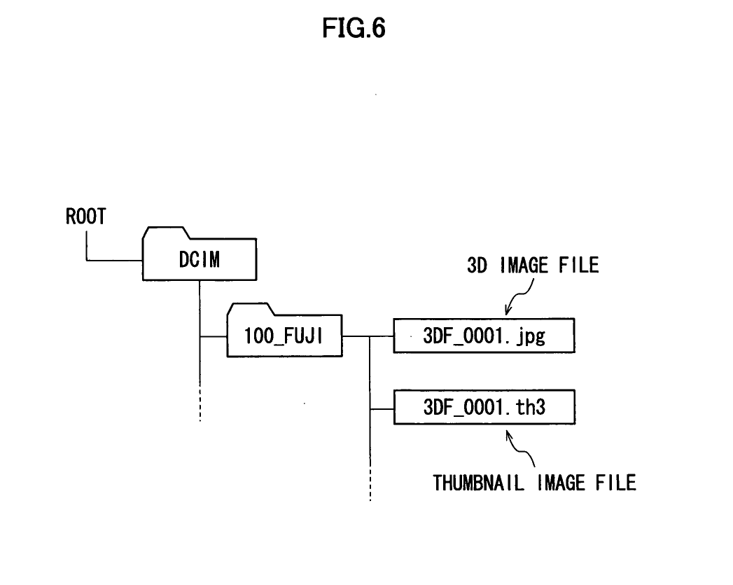

FIG. 6 shows the directory structure of the recording medium. As shown in the figure, a DCF folder (100_FUJI) is created under a DCF image root directory DCIM (Digital Camera IMages), and the 3D image file and the thumbnail image file described above are stored in the DCF folder.

A folder name and file names are automatically generated in accordance with predetermined naming rules and given to the DCF folder, the 3D image file and the thumbnail image file created as described above.

In this embodiment, the folder name and the file names are automatically generated on the basis of the DCF rules. The folder name of the DCF folder is created as shown in the table below.

TABLE 1

| | Folder number | Arbitrary characters |
|---|---|---|
| Rules | (100 to 999) | (five characters) |
| Example | 100 | ABCDE |

In the case where a DCF folder does not exist immediately under the DCF image root directory DCIM, the initial value of the folder number may be any number. In the case where the DCF folder exists, a consecutive number, that is, the maximum number+1 is recommended as the folder number of a newly created DCF folder.

The filenames of the image files (DCF files) are created as shown in the table below.

TABLE 2

| | Arbitrary characters | File number |
|---|---|---|
| Rules | (four characters) | (0001 to 9999) |
| Example | ABCD | 0001 |

In the case where a DCF file does not exist in the DCF folder, the initial value of the file number may be any number. In the case where a DCF exists, a consecutive number, that is, the maximum number+1 is recommended as the file number of a newly created DCF file.

As shown in FIG. 6, the 3D image file and the thumbnail image file corresponding to the 3D image file have a common filename though the extensions are different (the extension of the 3D image file is jpg, and the extension of the thumbnail image file is th3), and thereby both files are associated with each other.

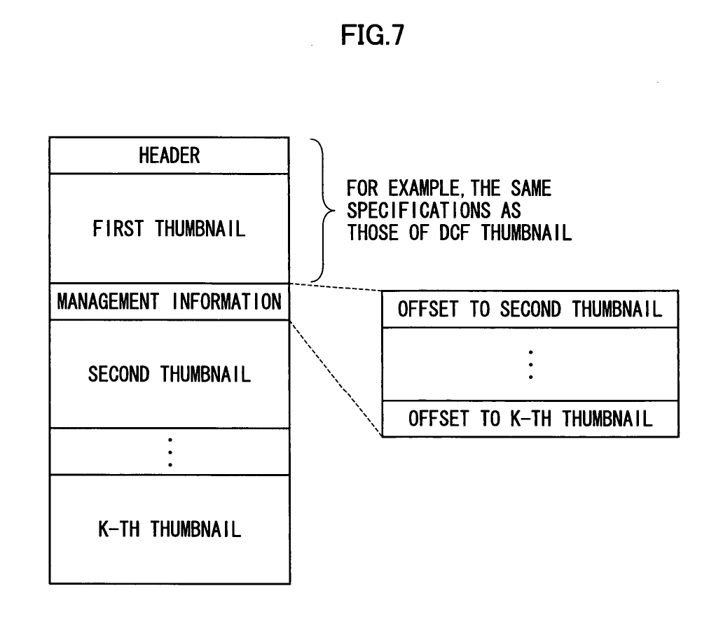

FIG. 7 is a diagram showing a file structure showing another embodiment of the thumbnail image file created by the thumbnail image file creation section 140 shown in FIG. 2.

As shown in FIG. 7, in this thumbnail image file, one thumbnail image (the first thumbnail image) among multiple types of thumbnail images is recorded immediately after the header, management information is recorded immediately after the first thumbnail image, and the thumbnail images other than the first thumbnail image (the second thumbnail image, . . . the K-th thumbnail image) are recorded immediately after the management information.

In the management information, offsets of the second and subsequent thumbnail images and the thumbnail image identifiers (type IDs) of the first to K-th thumbnail images are recorded.

According to the thumbnail image file in the above file structure, even an image reproduction device incapable of referring to the management information can reproduce at least the first thumbnail image because, as for the header and the first thumbnail image, the specifications are the same as the specifications of a thumbnail image file in accordance with DCF.

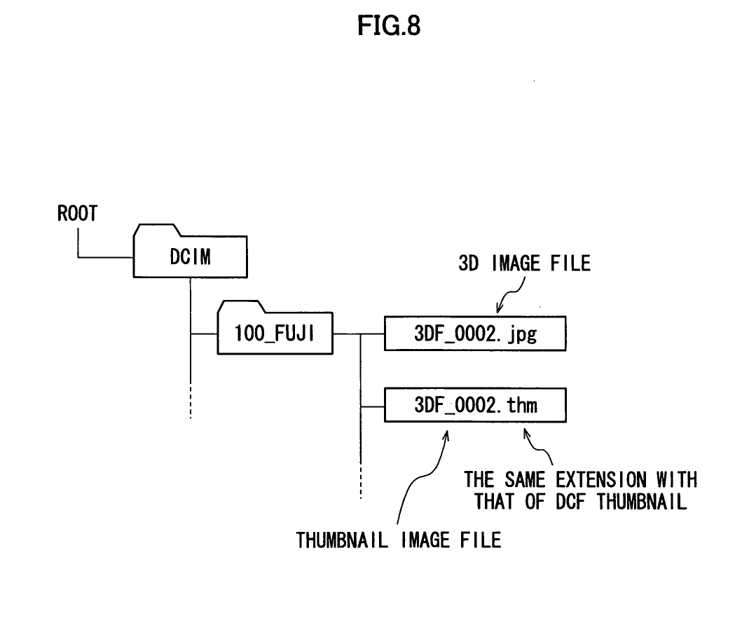

As the extension of the above thumbnail image file, thm (the same extension of a DCF thumbnail image file) is used as shown in FIG. 8. Thereby, the compatibility with conventional DCF thumbnail image files can be secured.

### [Image Reproduction Device]

Next, the details of the image reproduction device 300 shown in FIG. 1 will be described.

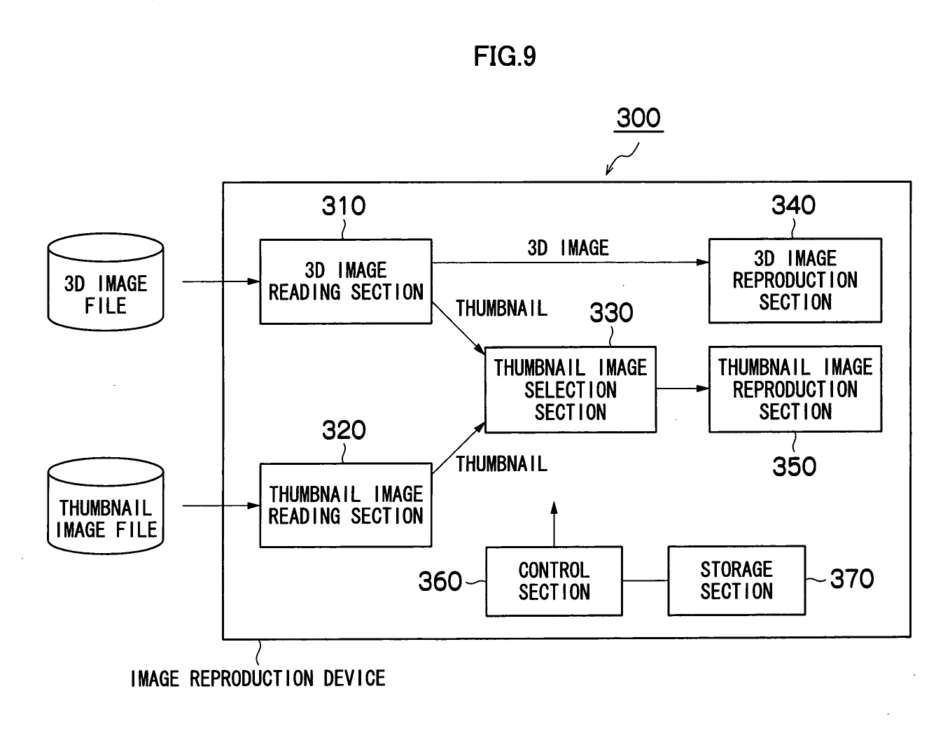

FIG. 9 is a block diagram showing the internal configuration of the image reproduction device 300.

This image reproduction device 300 is configured mainly by a 3D image reading section 310, a thumbnail image reading section 320, a thumbnail image selection section 330, a 3D image reproduction section 340, a thumbnail image reproduction section 350, a control section 360 and a storage section 370.

The control section 360 performs overall control of the components and controls them in accordance with a predetermined program. In the storage section 370, there are stored programs to be executed by the control section 360 and setting data and the like of the components.

The 3D image reading section 310 and the thumbnail image reading section 320 can read a 3D image file and a thumbnail image file, respectively, from the recording device 200.

The thumbnail image selection section 330 selects a thumbnail image of the type set on the apparatus in advance, from among multiple types of thumbnail images and outputs the selected thumbnail image to the thumbnail image reproduction section 350.

The thumbnail image reproduction section 350 displays the thumbnail image inputted via the thumbnail image selection section 330 on a display device provided for the digital camera 1, such as a liquid crystal monitor, or an external 3D image display device connected to the digital camera 1.

When a desired thumbnail image (a 3D image to be reproduced) is selected by a user from among the thumbnail images (for example, an index image constituted by multiple thumbnail images) displayed on the display device, the 3D image reproduction section 340 displays the 3D image to be inputted via the 3D image reading section 310 on the display device.

The 3D image reproduction section 340 creates a 3D image which can be recognized as a 3D image with special glasses and displays it on the display device, and, in the case of a display device capable of reproducing a 3D image without special glasses (for example, a directional display), it creates a 3D image compatible with the display device and displays it on the display device.

### [Image Reproduction Procedure]

By switching the mode of the digital camera 1 shown in FIG. 1 to a reproduction mode, it is possible to reproduce a 3D image.

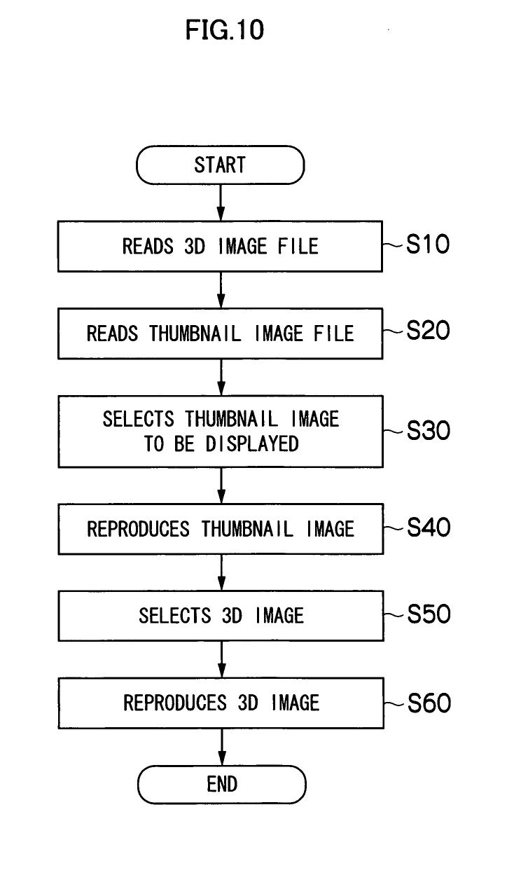

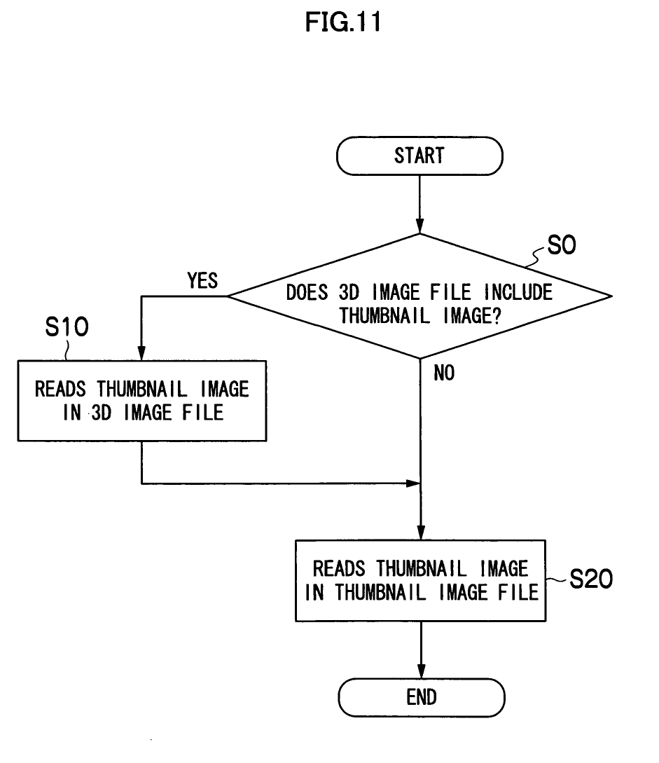

FIGS. 10 and 11 are flowcharts showing an embodiment of an image reproduction operation performed in the reproduction mode.

As shown in FIG. 10, a 3D image file is read from a recording medium first (step S10), and then, a thumbnail image file is read (step S20).

Since there may be a case where the 3D image file does not include a thumbnail image (in the case of FIGS. 5A and 5B), it is judged whether or not the 3D image file includes a thumbnail image as shown in FIG. 11 (step S0). If the 3D image file includes a thumbnail image, the flow proceeds to step S10. If the 3D image file does not include a thumbnail image, the flow skips step S10 and proceeds to step S20.

Next, a thumbnail image to be displayed is selected from the read thumbnail images (step S30). Specifically, a preset thumbnail image identifier (type ID) and type IDs of the thumbnail image recorded in the management information of the tag data shown in FIG. 4 are compared with each other, and a thumbnail image having the same type ID as the preset type ID is selected. It is only the management information in the image file that is read by the reading of the image file at steps S10 and S20.

Subsequently, the thumbnail image selected at step S30 is read from the thumbnail image file (or the 3D image file) on the basis of the offset to the thumbnail image recorded in association with the type ID, and the read thumbnail image is displayed on a display device (step S40).

Generally, the thumbnail image is displayed as an index image constituted by multiple thumbnail images. That is, one thumbnail image is selected for each image file stored in the recording medium, and the selected thumbnail image is read. And an index image of the thumbnail images is created from the read thumbnail images and displayed.

Next, a desired thumbnail image is selected from the index image. When reproduction of a 3D image corresponding to the thumbnail image is instructed (step S50), the 3D image is read from a 3D image file associated with the thumbnail image file in which the selected thumbnail image is recorded, and the 3D image is displayed on the display device (step S60). If the selected thumbnail image is recorded in the 3D image file, an original image (3D image) in the 3D image file is read, and the 3D image is displayed on the display device.

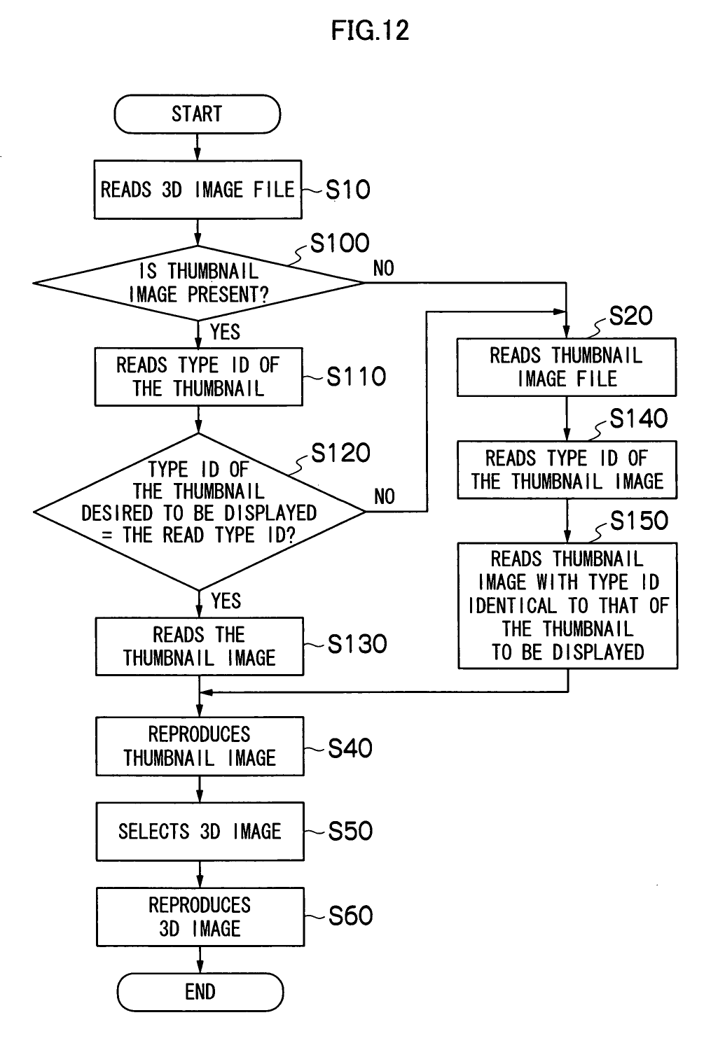

FIG. 12 is a flowchart showing another embodiment of the image reproduction operation performed in the reproduction mode. In FIG. 12, the steps common to the flowchart shown in FIG. 10 are given the same step numbers, and the detailed description thereof is omitted.

The image reproduction operation shown in FIG. 12 is different from the image reproduction operation shown in FIG. 10 in that, when a thumbnail image to be displayed is recorded in a 3D image file, the operation of reading a thumbnail image file is omitted.

That is, it is judged whether or not a thumbnail image is recorded in a 3D image file read from a recording medium (step S100).

If a thumbnail image is recorded, the type ID of the thumbnail image recorded in the management information (see FIG. 5C) is read (step S110), and it is judged whether or not the read type ID corresponds to the type ID of a thumbnail image to be displayed (step S120).

If the type IDs correspond to each other, the thumbnail image recorded in the 3D image file is read (step S130), and the flow proceeds to step S40. In this case, reading of a thumbnail image file is not performed.

On the other hand, if it is judged at step S100 that a thumbnail image is not recorded in the 3D image file (in the case of FIGS. 5A and 5B) or if it is judged at step S120 that the thumbnail image in the 3D image file is not the thumbnail image to be displayed (the type IDs do not correspond to each other), the flow proceeds to step S20.

At step S20, a thumbnail image file is read. Then, the type IDs of thumbnail images are read from the management information in the thumbnail image file (step SI 40), a thumbnail image having the same type ID as the preset type ID is read from the thumbnail image file (step S150), and the flow proceeds to step S40.

If the thumbnail image to be displayed is included in neither the 3D image file nor the thumbnail image file, any one of the multiple thumbnail images (for example, the first thumbnail image) may be displayed.

If the thumbnail image to be displayed is included in neither the 3D image file nor the thumbnail image file, the thumbnail image to be displayed may be created from the 3D image and displayed. Furthermore, it is also possible to add the created thumbnail image to the thumbnail image file and update the management information.

### [Another Embodiment of the 3D Image File]

In the above embodiments, the 3D image file and the thumbnail image file are separately created and recorded in association with each other. In the case of another embodiment of the 3D image file, however, multiple types of thumbnail images are recorded in the 3D image file without creating the thumbnail image file.

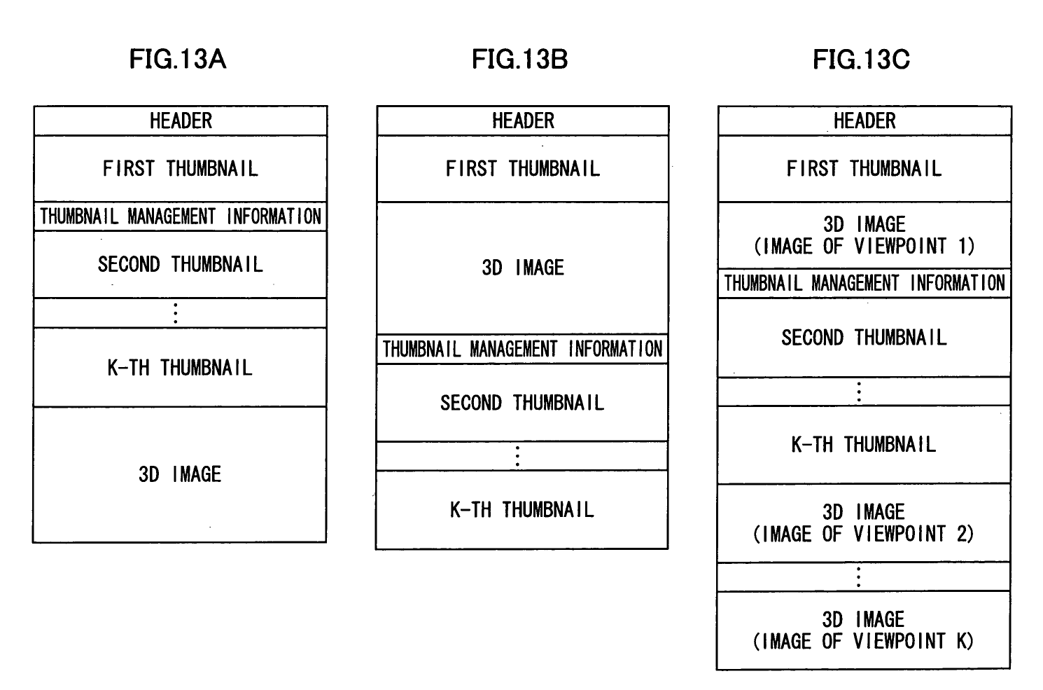

FIG. 13A to 13C are diagrams showing a file structure showing another embodiment of the 3D image file.

A first file structure of the 3D image file shown in FIG. 13A is the file structure of FIG. 5C in which the areas of the thumbnail image and the management information are replaced with the first to K-th thumbnail images in FIG. 7.

There may be a case where the compatibility can be secured by the above first file structure. Actually, however, as for the case of applying the first file structure to the current Exif (Exchangeable Image File Format) standard, there is a possibility that the compatibility cannot be secured because the first file structure cannot comply with the size restriction of the Exif standard, depending on the total size of the thumbnail images.

A second file structure of the 3D image file shown in FIG. 13B can solve the problem of the above first file structure. The file structure is such that only the first thumbnail image is stored in the areas of the thumbnail image and the management information in FIG. 5C, and the thumbnail management information and the second to K-th thumbnail images are arranged after the 3D image (original image).

The 3D image in the first and second file structures may be the integrated image shown in FIG. 5A or may be the image shown in FIG. 5B in which the images corresponding to respective viewpoints are separated and combined.

A third file structure of the 3D image file shown in FIG. 13C is applied only to the case where images corresponding to respective viewpoints are separated as a 3D image. The header, the first thumbnail image, and a 3D image corresponding to the viewpoint 1 are recorded in the format in conformity with the current Exif standard. After that, the thumbnail management information of the thumbnail, the second to K-th thumbnail images, and the 3D images corresponding to the viewpoints 2 to K are arranged.

In the case of the image file creation device for creating a 3D image file which is shown in FIG. 13A to 13C, the necessity of the thumbnail image file creation section 140 in the image file creation device 100 shown in FIG. 2 is eliminated, and all of the multiple types of thumbnail images created by the thumbnail image creation section 120 and all the tag data created by the tag data creation section 130 are outputted to the 3D image file creation section 150, where the 3D image file shown in FIG. 13 is created.

In the image reproduction device for reproducing a 3D image file which is shown in FIG. 13A to 13C, the necessity of the thumbnail image reading section 320 in the image reproduction device 300 shown in FIG. 9 is eliminated.

In this embodiment, description has been made on the assumption that the image file creation device and the image reproduction device are incorporated in the digital camera. However, the image file creation device and the image reproduction device may be separate devices.

What is claimed is:

1. An image file creation device comprising:
an image acquisition device which acquires a three-dimensional image constituted by multiple images obtained by capturing images of the same subject from multiple viewpoints;
a thumbnail image creation device which creates two or more types of thumbnail images on the basis of the acquired three-dimensional image;
a three-dimensional image file creation device which creates a three-dimensional image file from the acquired three-dimensional image; and
a thumbnail image file creation device which creates a thumbnail image file in which the created two or more types of thumbnail images are combined and recorded and which is associated with the three-dimensional image file.

2. The image file creation device according to claim 1, further comprising a tag data creation device which creates management information for managing the created two or more types of thumbnail images; wherein
the thumbnail image file creation device records the management information in the thumbnail image file.

3. An imaging apparatus comprising:
the image file creation device according to claim 1;
an imaging device which captures a plurality of images of the same subject from multiple viewpoints and outputs the plurality of captured images to the image acquisition device; and
a storage device which stores the three-dimensional image file created by the three-dimensional image file creation device and the thumbnail image file created by the thumbnail image file creation device in a storage medium.

4. The image file creation device according to claim 1, wherein the three-dimensional image file creation device records one of the created two or more types of thumbnail images in the three-dimensional image file.

5. The image file creation device according to claim 4, further comprising a tag data creation device which creates management information for managing the created two or more types of thumbnail images; wherein
the thumbnail image file creation device records the management information in the thumbnail image file.

6. An image file creation device comprising:
an image acquisition device which acquires a three-dimensional image constituted by multiple images obtained by capturing images of the same subject from multiple viewpoints;
a thumbnail image creation device which creates two or more types of thumbnail images on the basis of the acquired three-dimensional image;
a three-dimensional image file creation device which creates a three-dimensional image file from the acquired three-dimensional image and one of the created two or more types of thumbnail images; and
a thumbnail image file creation device which creates a thumbnail image file in which one or more types of thumbnail images among the created two or more types of thumbnail images, excluding the thumbnail image included in the three-dimensional image file, are recorded and which is associated with the three-dimensional image file.

7. The image file creation device according to claim 6, further comprising a tag data creation device which creates management information for managing the created two or more types of thumbnail images; wherein
the thumbnail image file creation device records the management information in the thumbnail image file.

8. An imaging apparatus comprising:
the image file creation device according to claim 6;
an imaging device which captures a plurality of images of the same subject from multiple viewpoints and outputs the plurality of captured images to the image acquisition device; and
a storage device which stores the three-dimensional image file created by the three-dimensional image file creation device and the thumbnail image file created by the thumbnail image file creation device in a storage medium.

9. An image file creation device comprising:
an image acquisition device which acquires a three-dimensional image constituted by multiple images obtained by capturing images of the same subject from multiple viewpoints;
a thumbnail image creation device which creates two or more types of thumbnail images on the basis of the acquired three-dimensional image; and
a three-dimensional image file creation device which creates from the acquired three-dimensional image, a three-dimensional image file in which the two or more types of thumbnail images created by the thumbnail image creation device are recorded.

10. The image file creation device according to claim 2, wherein the thumbnail image file creation device records the management information immediately after the header of the thumbnail image file.

11. The image file creation device according to claim 2, wherein the thumbnail image file creation device records the management information immediately after the thumbnail image recorded immediately after the header of the thumbnail image file.

12. The image file creation device according to claim 9, further comprising a tag data creation device which creates management information for managing the created two or more types of thumbnail images; wherein
the three-dimensional image file creation device records the management information in the three-dimensional image file.

13. The image file creation device according to claim 2, wherein the management information includes a thumbnail image identifier which identifies the type of a thumbnail image.

14. A file structure of a thumbnail image file in which multiple different types of thumbnail images are combined and recorded, the multiple thumbnail images being created from a three-dimensional image constituted by multiple images obtained by capturing images of the same subject from multiple viewpoints, wherein
a first thumbnail image among the multiple thumbnail images is recorded immediately after a header;
management information managing the multiple thumbnail images is recorded immediately after the first thumbnail image; and
the thumbnail images other than the first thumbnail image are recorded immediately after the management information.

15. The file structure according to claim 14, wherein the management information includes a thumbnail image identifier which identifies the type of each thumbnail image.

16. A file structure of a three-dimensional image file in which a three-dimensional image constituted by multiple images obtained by capturing images of the same subject from multiple viewpoints and multiple different types of thumbnail images created from the three-dimensional image are recorded, wherein
a first thumbnail image among the multiple thumbnail images is recorded immediately after a header;
management information managing the multiple thumbnail images is recorded immediately after the first thumbnail image;
the thumbnail images other than the first thumbnail image are recorded immediately after the management information; and
the three-dimensional image is recorded immediately after the multiple thumbnail images.

17. The file structure according to claim 16, wherein the three-dimensional image is an integrated image obtained by integrating multiple images as one image or an image obtained by separating and combining images corresponding to respective viewpoints.

18. The file structure according to claim 16, wherein the management information includes a thumbnail image identifier which identifies the type of each thumbnail image.

19. A file structure of a three-dimensional image file in which a three-dimensional image constituted by multiple images obtained by capturing images of the same subject from multiple viewpoints and multiple different types of thumbnail images created from the three-dimensional image are recorded, wherein
a first thumbnail image among the multiple thumbnail images is recorded immediately after a header;
the three-dimensional image is recorded immediately after the first thumbnail image;
management information managing the multiple thumbnail images is recorded immediately after the three-dimensional image; and
the thumbnail images other than the first thumbnail image are recorded immediately after the management information.

20. The file structure according to claim 19, wherein the management information includes a thumbnail image identifier which identifies the type of each thumbnail image.

21. The file structure according to claim 19, wherein the three-dimensional image is an integrated image obtained by integrating multiple images as one image or an image obtained by separating and combining images corresponding to respective viewpoints.

22. A file structure of a three-dimensional image file in which a three-dimensional image constituted by multiple images obtained by capturing images of the same subject from multiple viewpoints and multiple different types of thumbnail images created from the three-dimensional image are recorded, wherein
a first thumbnail image among the multiple thumbnail images is recorded immediately after a header;
an image corresponding to a first viewpoint of the three-dimensional image is recorded immediately after the first thumbnail image;
management information managing the multiple thumbnail images is recorded immediately after the image corresponding to the first viewpoint;
the thumbnail images other than the first thumbnail image are recorded immediately after the management information; and
the images other than the image corresponding to the first viewpoint, of the three-dimensional image are recorded immediately after the multiple thumbnail images.

23. The file structure according to claim 22, wherein the management information includes a thumbnail image identifier which identifies the type of each thumbnail image.

24. The file structure according to claim 23, wherein the management information includes information indicating the positions in the file of the thumbnail images other than the first thumbnail image among the multiple thumbnail images.
